(19) United States
(12) Patent Application Publication
(10) Pub. No.: US 2005/0044419 A1
(43) Pub. Date: Feb. 24, 2005

(54) System and method of internet access and management

(76) Inventors: Mark Jones, Ottawa (CA); Yong Li, Kanata (CA); Parham Momtahan, Ottawa (CA)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/900,400

(22) Filed: Jul. 28, 2004

Related U.S. Application Data
(60) Provisional application No. 60/490,256, filed on Jul. 28, 2003.

(51) Int. Cl. H04L 9/00

(52) U.S. Cl. 713/201

(57) ABSTRACT

A RADIUS server is provided with the capability of authenticating a wireless access point whose IP network address has been dynamically allocated. One the wireless access point has received its IP network address on booting a request for authentication is sent to the RADIUS server from a wireless access point. The RADIUS server determines a MAC address, a IP network address, and an authenticator from the request. The MAC address is used to determine a shared secret which is used to verify the message attribute authenticator for the request, which is used for verifying both addresses. The method and apparatus can be applied to other AAA server protocols, for example Diameter protocol.

The present invention relates generally to telecommunications, and more specifically, to a system and method of Internet access and management.

### BACKGROUND OF THE INVENTION

There are many situations in which it is more effective to allocate dynamic IP address to devices rather than static IP addresses. Dynamic IP address allocation enables devices to be moved from one IP subnet to another without requiring costly reconfiguration, and it allows more efficient use of IP addresses that are scarce. However, where these devices are authenticators, such as 802.1x network access points or other network access servers, that are required to carry out authentication, authorization, and accounting (AAA) requests against servers based on the RADIUS protocol, this has hitherto not been easy to achieve.

RADIUS is a protocol for authenticating users who dial in to private networks. Typically, dial-in network access servers challenge callers for user name and password, which are checked against a RADIUS server. Optionally, a switch can collect PIN# (Personal Identification Number) from the user (using an Intelligent Peripheral) and send the PIN # as username authentication parameter to the ISP's Authentication, Authorization, and Accounting (AAA) server.

This is because the RADIUS server has hitherto needed to be given prior knowledge of the IP address of the authenticator device, and as the device address would change, the RADIUS server would need to be re-provisioned with the changed device address.

Referring to FIG. 1, this is illustrated in a black diagram an exemplary Internet network as known in the prior art. In FIG. 1 components of interest are shown. The Internet network 10 includes a dynamic host configuration protocol (DHCP) a server 12, a domain name system (DNS) server 14, a remote authentication dial-in service (RADIUS) server 16 and a network access server (NAS).

Referring to FIG. 2, there is illustrated message flow between the servers of FIG. 1. When a new network access server needs to be connected to the Internet network 10. The following steps are taken as shown in FIG. 2.
1. The NAS 18 requests and obtains an IP address from the DHCP Server 12
2. The DHCP 12 also provides the allocated IP address +name to the DNS server 14.
3. The RADIUS server 16 looks up IP address based on name at the DNS server 14.
4. The NAS 18 can now make normal authentication requests from RADIUS server 1

Normally a RADIUS normally server authenticates clients that have a static IP address. Once the RADIUS server receives the authentication request, it validates the sending client. A request from a client for which the RADIUS server does not have a shared secret must be silently discarded.

The RADIUS server uses the source IP address of the request packet to select the appropriate shared secret

If the client is valid, the RADIUS server proceeds with the authentication of the user credentials.

The original RADIUS RFC [RFC2865] did not include a means to ensure that the packet was not modified during transit, and the NAS-IP-Address attribute could not be used to select the shared secret for fear that it had been forged. For this reason, RADIUS server implementations were required to use the source IP address extracted from the packet header.

Later versions of the RADIUS server can ensure that the packet was not modified during transit. This is because RADIUS Extensions RFC [RFC2869] introduced the Message-Authenticator attribute, which eliminates this risk of forgery. The Message-Authenticator is an HMAC-MD5 checksum of the entire Access-Request packet, including Type, ID, Length and authenticator, using the shared secret as the key, as follows.

Message-Authenticator=HMAC-MD5 (Type, Identifier, Length, Request Authenticator, Attributes)

For successful interoperability, wireless NAS need to be compliant with [IEEE8021X] and follow the RADIUS usage guidelines documented in [CONGDON]. Compliant devices must use the Message-Authenticator attribute to protect packets within a RADIUS/EAP conversation.

Since doing so cause problems, one might ask why use dynamic IP address allocation? Deploying an 802.1x network requires a special type of wireless NAS, also known as a wireless access point. These wireless NAS have capacity and range limitations which means many more wireless NAS need to be deployed than would be required in a wired network deployment for an equivalent number of users. Dynamic IP address allocation protocols, e.g. DHCP, offers a means to centralize the IP address management for the wireless NAS. It also simplifies the ‘bootstrapping’ of the wireless NAS since these devices typically issue a IP address request the first time they are connected to the LAN. Once an IP address has been issued, other IP-based management protocols, e.g. telnet, HTTP or SNMP, can be used to complete the configuration of the device.

Given the desirability of using dynamic address allocation, why does the RADIUS authentication scheme break down when dynamic IP address allocation is used? The NAS issues an IP address request when it boots and is allocated a new IP address by the dynamic IP address allocation server, for example DCHP server 12 in FIG. 1. The IP address is allocated from a pool of unused IP addresses and the actual value cannot be predicted. Hence, the RADUS server 16 cannot maintain a static map of IP address to shared secret.

### SUMMARY OF THE INVENTION

It is therefore an object of the invention to provide an improved system and method of Internet access and management.

In accordance with an aspect of the present invention there is provided a server for authenticating a client comprising: means for receiving a request for authentication from a client; means for determining an attribute and a network address from the request; and means for authenticating the network address in dependence upon the attribute.

In accordance with an aspect of the present invention there is provided a method of authenticating a client comprising the steps of: receiving a request for authentication from a client; determining an attribute and a network address from the request, the network address being a dynamically allocated address; and authenticating the network address in dependence upon the attribute.

In accordance with an aspect of the present invention there is provided a RADIUS server for authenticating a wireless access point comprising: a receiver for receiving a request for authentication from a wireless access point; a reader for determining a MAC address, a IP network address, and an authenticator from the request; and a verifier for verifying the addresses in dependence upon the authenticator.

However, with the method of the present invention, the RADIUS server can auto-discover the IP address of the authenticator device, obviating the need for the device to be statically configured, or the RADIUS server to be provisioned with the IP address of the device.

Consequently, the method of the present invention makes reduces the complexity and enhances the cost-effectiveness of having authenticator devices with dynamically allocated IP addresses. Furthermore, through the discovery process the RADIUS server becomes an authoritative source for the device IP addresses, hence other applications, such as management or web interfaces, can utilize the RADIUS server to access the device through its discovered address.

Accordingly the present invention to provides a method of authenticating RADIUS clients where the IP address of the client is unknown, for example, when the IP address is dynamically allocated via a DHCP server.

One aspect of the invention is the use of a RADIUS attribute, which contains the MAC (Media Access Control), to authenticate the RADIUS client and reliably ascertain its IP address.

An additional aspect of the invention is defined as the ability of the RADIUS server to publish a map of the MAC address to IP address. This map can be used to offer a translation service for other NAS management applications.

### BRIEF DESCRIPTION OF THE DRAWINGS

Theses and other features of the invention will become more apparent from the following description in which reference is made to the appended drawings in which:

FIG. 1 illustrates in a block design an exemplary Internet network as known in the prior art;

FIG. 2 illustrates a known message flow between the servers of FIG. 1;

FIG. 3 illustrates in a block diagram an exemplary Internet Network;

FIG. 4 illustrates a message flow between servers in FIG. 3 in accordance with an embodiment of the present invention.

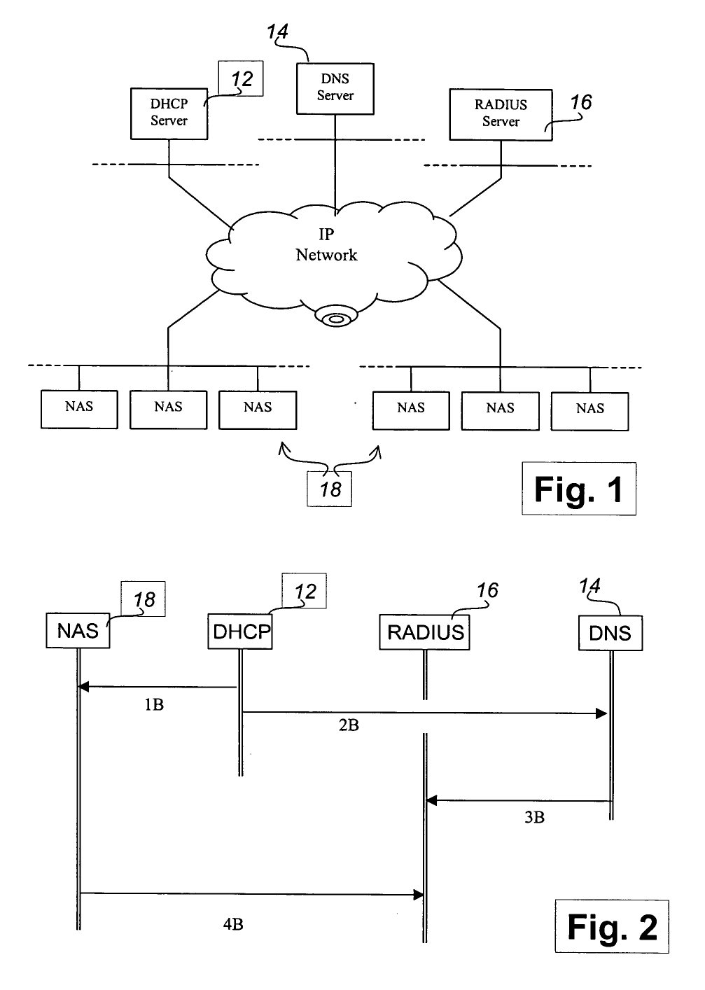

### DETAILED DESCRIPTION OF THE PREFERRED EMBODIMENTS OF THE INVENTION

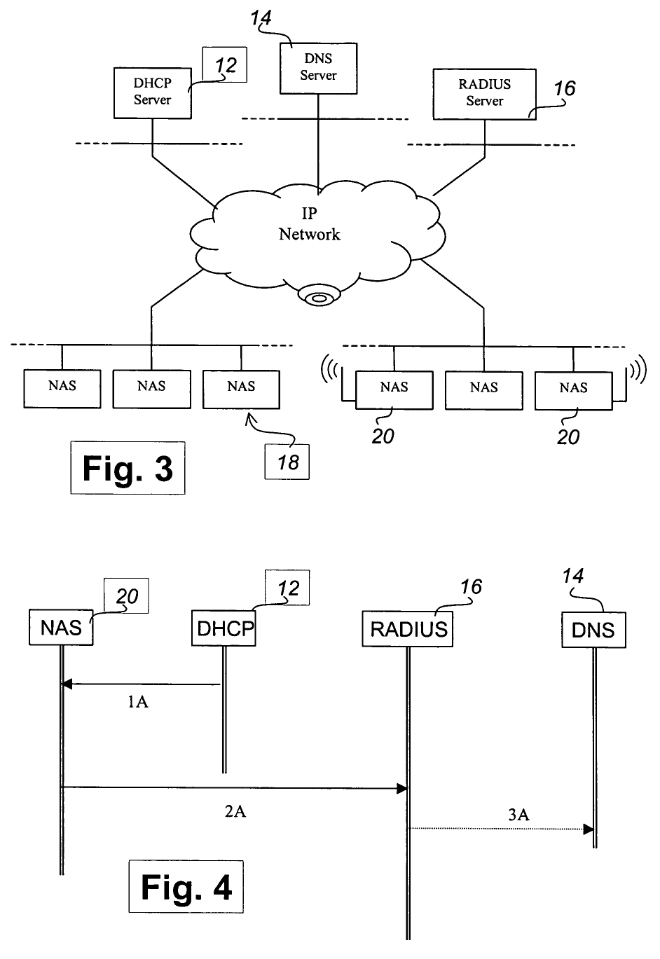

Referring to FIG. 3, there is illustrated in a block diagram an exemplary Internet network including wireless network access servers 20 in which the present invention may be used. The Internet network 10 includes wireless network access servers 20. Unlike network access servers (NAS) 18 whose network address are fixed, wireless NAS 20 issue an IP address request when it boots.

Referring to FIG. 4, there is illustrated message flow between the servers of FIG. 2. When the wireless NAS 20 reboots the following sequence occurs:
1. The wireless NAS 20 requests and obtains an IP address from the DHCP server 12.
2. The wireless NAS 20 makes normal authentication request to the RADIUS server 16 from which the RADIUS server learns the NAS IP address using the described algorithm which is tamper proof in the sense that a made up (or spoofed) IP address is guarded against.
3. OPTIONAL STEP: RADIUS (optionally) provides the learned IP—Name mapping to the DNS server 14.

As is evident from comparing FIG. 4, with prior art FIG. 2, no additional steps are required for a NAS 20 with dynamic IP address to operate correctly with RADIUS server 16 since RADIUS server learns the IP address of the NAS in a tamper proof manner. Before the present invention two additional steps (2B, 3B) were mandatory for correct operation.

Hence, the invention reduces operational complexity and leads to better performance since the RADIUS server 16 is not required to frequently synchronize with the DNS server 14, before the NAS 20 can send authorization requests to the RADIUS server 16.

In accordance with an embodiment of the present invention, the RADIUS server 16 maintains a static map of MAC (Media Access Control) address to shared secret. This MAC address is assigned to the device during the manufacturing process and cannot be modified.

If the NAS 20 were on the same LAN subnetwork as the RADIUS server 16, the RADIUS server 16 could simply extract the source MAC address from the IP header of the request packet and use it to select the appropriate shared secret. However, this imposes an unacceptable restriction on the deployment since it requires a RADIUS server 16 be located on the same LAN subnetwork as the NAS 20.

A reliable method of determining the MAC address of wireless NAS 20 is facilitated by [CONGDON]. This IETF Internet draft states that a compliant wireless NAS 20 will store its MAC address in the Called-Station-Id attribute.

Using the MAC address, the RADIUS server 16 is now able to select the appropriate shared secret for the NAS 20 and must use it to verify the value in the Message-Authenticator attribute. If the Message-Authenticator is valid, the RADIUS server 16 proceeds with the authentication of the user credentials.

Since the Message-Authenticator checksum is calculated over the entire packet, the validation of the Message-Authenticator ensures that the MAC address (in the Called-Station-Id attribute) and the IP Address (in the NAS-IP-Address attribute) have not been tampered with. The RADIUS server 16 now has the information needed to build a lookup table from MAC address to IP address. This lookup table can be made available via an API (out of scope) which provides a translation service from MAC address to IP address for other NAS 20 management applications.

Since the IP address of the NAS 20 may change over time, the algorithm used to maintain the lookup table is:
Extract the MAC address from the Called-Station-Id attribute and look it up in the MAC to IP address table.
If an entry for the MAC address exists, compare the IP address in the table to that in the NAS-IP-Address attribute. If the IP addresses are different, the NAS has changed its IP address and so the entry in the table must be updated with the new value from the NAS-IP-Address attribute.
If an entry for the MAC address does not exist, insert a new value in the table. The new table entry will map the MAC address (from the Called-Station-Id attribute) to the IP address (from the NAS-IP-Address attribute).

Optionally, the RADUS server can make the NAS IP address information available to external applications

The RADIUS server 16 can make the NAS IP address available to external applications via an API or using Secure Domain Name System (DNS) Dynamic Update to create a new mapping entry in a DNS server 14 from the NAS name to IP address as shown in FIG. 4. The later method requires, the RADIUS server 16 to model the ‘user-friendly’ name for the NAS along with the MAC Address.

The IP address of the NAS 20 is required in order to perform configuration management functions via TCP/IP or UDP/IP protocols, e.g. HTTP or SNMP. By using the Secure DNS Update method described above, the NAS can always be addressed with a user-friendly name regardless of IP address changes.

The RADIUS server 16 is aware of the IP to MAC address mapping in order to process unsolicited messages destined for the NAS. These messages enable dynamic authorization functions as defined in [CHIBA]. This draft RFC describes an extension to the RADIUS protocol, allowing dynamic changes to a user session on a NAS. This includes support for disconnecting users and changing authorizations applicable to a user session.

Another AAA protocol is DIAMETER, which is like RADIUS. Although DIAMETER has several other advantages over RADIUS, which may result in the growth of its use in the industry. RADIUS was designed to function only with Serial Line Internet Protocol and PPP for standard analog modems, while DIAMETER can be used for access authentication of handheld or other wireless computing devices, cellular phones or Ethernet-based virtual private networks (VPN). As well, DIAMETER allows remote servers to send unsolicited messages to clients, and has longer address spaces.

While the above description of embodiments of the present invention assumes RADIUS is the AAA protocol, the Diameter protocol can also be used with the same effect. Since Diameter was intended to be backwards compatible with RADIUS, the message sequences in the above diagrams remain unchanged but the names of some of the Diameter messages are different.

While particular embodiments of the present invention have been shown and described, it is clear that changes and modifications may be made to such embodiments without departing from the true scope and spirit of the invention.

The method steps of the invention may be embodied in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory means such computer diskettes, CD-Roms, Random Access Memory (RAM), Read Only Memory (ROM) or similar computer software storage media known in the art, may be programmed to execute such method steps. As well, electronic signals representing these method steps may also be transmitted via a communication network.

It would also be clear to one skilled in the art that this invention need not be limited to the described scope of computers and computer systems. The system of the invention could be applied, for example, to point of sale terminals, vending machines, pay telephones, Internet-ready cellular telephones, or public Internet Kiosks. Again, such implementations would be clear to one skilled in the art, and do not take away from the invention.

Additional aspects and embodiments of the present invention may include:
1. A method for authenticating RADIUS clients where their IP address is dynamically allocated.
2. A method of constructing a reliable map of MAC address to IP address for RADIUS clients.
3. A method of constructing a reliable map of IP address to name for RADIUS clients.
4. A method of authenticating RADIUS clients wherein the RADIUS server can auto-discover the IP address of the authenticator device.
5. The method of embodiment 1, wherein the IP address is dynamically allocated using DHCP.
6. A method of authenticating clients wherein a RADIUS attribute which contains the MAC (Media Access Control) is used to authenticate the RADIUS client.
7. A method of system management comprising the step of publishing a map of MAC addresses to IP addresses.
8. A method of system administration in which a RADIUS server generates and maintains a map of an identifier assigned to a device during manufacturing, to a to shared secret.
9. The method of embodiment 8, wherein said identifier is a MAC address.
10. A method of authentication where a server extracts a source MAC address from the IP header of a request packet.
11. The method of embodiment 10, wherein the network is wireless and the MAC address is determined using the technique described by [CONGDON].
12. The method of embodiment 10, wherein the network is wireless and the MAC address is stored in the Called-Station-Id attribute.
13. A method of system administration where a lookup table which provides a translation service from MAC address to IP address, is made available as an API.
14. An apparatus operable to execute the method steps of any one of embodiments 1-13.
15. A system operable to execute the method steps of any one of embodiments 1-13.
16. A computer readable memory medium storing software code which is executable to perform the method steps of any one of embodiments 1-13.
17. An electronic signal, defining computer readable code, which is executable to perform the method steps of any one of embodiments 1-13.

### REFERENCES

| | |
|---|---|
| [CHIBA] | Dynamic Authorization Extensions to Remote Authenti- |
| | cation Dial In User Service (RADIUS); Chiba, M., |
| | Dommety, G., Eklund, M., Mitton, D., Aboba, B. Inter- |
| | net draft (work in progress), draft-chiba-radius-dynamic- |
| | authorization-20.txt, 15 May 2003 |
| [CONGDON] | Congdon, P., Aboba, B., Smith, A, Zorn, G., and Roese, |
| | J., “IEEE 802.1X RADIUS Usage Guidelines”, Internet |
| | draft (work in progress), draft-congdon- radius-8021x- |
| | 29.txt, April 2003. |
| [RFC2865] | Rigney, C., Rubens, A., Simpson, W. and S. Willens, |
| | “Remote Authentication Dial In User Service |
| | (RADIUS)”, RFC 2865, June 2000. |
| [RFC2869] | Rigney, C., Willats, W. and P. Calhoun, “RADIUS Ex- |
| | tensions”, RFC 2869, June 2000. |
| [RFC2869bis] | Aboba, B. and P. Calhoun, “RADIUS Support for Exten- |
| | sible Authentication Protocol (EAP)”, Internet draft |
| | (work in progress), draft-aboba-radius- rfc2869bis- |
| | 18.txt, April 2003. |
| [RFC3007] | Wellington, B., “Secure Domain Name System (DNS) |
| | Dynamic Update”, RFC3007, November 2000. |
| [IEEE8021X] | IEEE Standards for Local and Metropolitan Area Net- |
| | works: Port based Network Access Control, IEEE Std |
| | 802.1X-2001, June 2001. |

1. A method of authenticating a client comprising the steps of:
receiving a request for authentication from a client;
determining an attribute and a network address from the request, the network address being a dynamically allocated address; and
authenticating the network address in dependence upon the attribute.

2. A method as claimed in claim 1 wherein the step of authenticating the network address includes the step of determining a media access control address (MAC).

3. A method as claimed in claim 2 wherein the step of authenticating includes determining a shared secret in dependence upon the media access control address (MAC).

4. A method as claimed in claim 3 including the step of verifying a message attribute authenticator in dependence upon the shared secret.

5. A method as claimed in claim 4 including the step of verifying MAC address and the network address in dependence upon the message attribute authenticator.

6. A method as claimed in claim 5 including the step of mapping the network address to the MAC address.

7. A method as claimed in claim 6 including the step of publishing the mapping of network address to MAC address to other servers.

8. A method as claimed in claim 7 wherein the network address is an Internet Protocol (IP) address.

9. A method as claimed in claim 1 wherein the step of receiving the request follows the client receiving a network address.

10. A RADIUS server for authenticating a wireless access point comprising:
a receiver for receiving a request for authentication from a wireless access point;
a reader for determining a MAC address, a IP network address, and an authenticator from the request; and
a verifier for verifying the addresses in dependence upon the authenticator.

11. A server for authenticating a client comprising:
means for receiving a request for authentication from a client;
means for determining an attribute and a network address from the request;
means for authenticating the network address in dependence upon the attribute.

12. A server as claimed in claim 11 wherein the means for determining an attribute includes means for determining a media access control address (MAC).

13. A server as claimed in claim 12 wherein the means for authenticating includes a means for mapping a shared secret in dependence upon the media access control address (MAC).

14. A server as claimed in claim 13 including means for verifying a message attribute authenticator in dependence upon the shared secret.

15. A server as claimed in claim 14 including means for verifying MAC address and the network address in dependence upon the message attribute authenticator.

16. A server as claimed in claim 15 a map of the network address to the MAC address.

17. A server as claimed in claim 16 including means for publishing the map of network address to MAC address to other servers.

18. A server as claimed in claim 17 wherein the network address is an Internet Protocol (IP) address.

19. A server as claimed in claim 11 wherein the step of receiving the request follows the client receiving a network address.

20. A server as claimed in claim 11 wherein the client is a wireless network access server.
